(19) United States
(12) Patent Application Publication
(10) Pub. No.: US 2011/0269587 A1
(43) Pub. Date: Nov. 3, 2011

(54) ONE-WAY OR SELECTABLE CLUTCH WITH MULTIPLE ROWS OF RATCHET ELEMENTS

(75) Inventor: James R. Papania, Bolingbrook, IL (US)

(73) Assignee: BORGWARNER INC., Auburn Hills, MI (US)

(21) Appl. No.: 13/124,684

(22) PCT Filed: Oct. 15, 2009
(86) PCT No.: PCT/US09/60863

§ 371 Date: Apr. 18, 2011

Related U.S. Application Data
(60) Provisional application No. 61/107,571, filed on Oct. 22, 2008.

(51) Int. Cl. F16D 41/12; F16H 7/00

(52) U.S. Cl. 474/148; 192/46

(57) ABSTRACT

A one-way or selectable clutch with multiple circumferential rows of ratchet elements is disclosed. The clutch may include two or more rows of ratchet elements extending between two or more races. The device may be either a one-way clutch or a selectable mechanical clutch, and afford the benefits of reduced backlash and multiple modes of operation. Those modes may include free-wheel/overrun in both clockwise and counterclockwise directions, lock/transmit torque in both directions, lock in clockwise and overrun in counterclockwise directions, and lock in counterclockwise and overrun in clockwise directions.

### CROSS-REFERENCE TO RELATED APPLICATION

This application is a Patent Cooperation Treaty patent application claiming priority under 35 USC 119(e) to U.S. Provisional Patent Application No. 61,107,571 filed on Oct. 22, 2008.

### FIELD OF THE DISCLOSURE

The present disclosure generally relates to clutch assemblies and, more particularly, relates to radial ratchet one-way and selectably-engageable clutches.

### BACKGROUND OF THE DISCLOSURE

Transfer cases are used in full and part-time, four-wheel drive vehicles to distribute driving power received through an input shaft from the vehicle transmission to a pair of output drive shafts. One of the drive shafts powers the vehicle front wheels and the other drive shaft powers the vehicle rear wheels. In vehicles permitting shifting between two wheel drive and four wheel drive modes, the input shaft of the transfer case provides continuous power to one of its output shafts and selectively provides drive power to the other output shaft by some type of disengageable or otherwise adjustable coupling, such as a viscous coupling, electro-magnetic clutch, or positionable spur gearing. Other drive modes are sometimes provided, including four-wheel drive high for higher four-wheel drive speeds, four-wheel drive low for lower driving speeds, and neutral for disengaging the transmission from the front rear axles to allow towing, and lock four-wheel drive for controlling wheel slippage.

Additionally, other transfer case applications have evolved, such as on demand four-wheel drive, in which a transfer case, with its related parts that provide four-wheel drive, is installed in the vehicle, yet four-wheel drive mode is only engaged, by automatic means, when there is a loss of two-wheel drive traction. Full time or constant, four-wheel drive mode, sometimes referred to as “all-wheel drive” is also currently available in some automotive variants. In this mode, four-wheel drive is not deselectable and remains a fixed configuration.

In the transfer cases used for these vehicles, certain elements, or components, are required to transmit the driving force. More particularly, certain elements are required to selectively transmit the driving force during particular driving situations but not in others. One example of a device used to selectively transmit driving or rotational force, in a transfer case, is a one-way clutch. One-way clutches are known devices having inner and outer races with an engagement mechanism disposed therebetween. Generally speaking, the engagement mechanism is designed to lock the races together when the relative rotation of the races is in one particular rotational direction. When the races rotate in the opposite relative direction, the engagement mechanism is unlocked and the races have free rotation relative to each other. In application, when the races are fixed to concentric shafts, the one-way clutch will function to hold the shafts together when engaged, causing them to rotate in the same direction and thereby transferring motive force, or drive torque, from one shaft to the other. When the one-way clutch is disengaged, the shafts thereby free-wheel relative to each other.

Specific applications govern how the one-way clutch engagement is designed. A one-way clutch may be designed to have one race as the driving member and one as the driven member, or the clutch may be designed to allow either shaft to act as the driving member during different operating modes. In this manner, the locking mechanism of the one-way clutch may be designed to engage in response to the rotation of only one of the races, or the clutch may be designed so as to engage if either race provides the proper relative rotation.

The one-way clutch is typically used in circumstances in which shaft to shaft, or shaft to race, rotational, torque-transferring engagements are desirable, but a “hard” connection such as a spline or keyed connection would not work. For example, during certain operating parameters, a four-wheel drive vehicle experiences driveline difficulties that arise from having the front and rear wheels cooperatively driven, which can be alleviated by the use of these one-way clutch devices within the transfer case. When a four-wheel drive vehicle turns a tight corner with four wheels coupled together on a paved road, the vehicle may experience what is known as “tight corner braking effect”. This happens due to the inherent physical geometry that affects objects rotating at different radial distances from a center point. Two distinct effects generally occur with four-wheel drive vehicles. First, when any vehicle enters a curve the wheels on the outside of the curve must traverse a greater circumferential distance than the wheels inside of the curve due the greater radial distance from the center of the curve. The tighter the curve, the greater difference in the rate of rotational, angular speed between the inner wheels and the outer wheels. Therefore, in a curve the outside wheels must rotate faster than the inner wheels. This effect is exaggerated in a four-wheel drive vehicle but is generally countered by the differential assemblies of the vehicle installed at the front and rear axles. Secondly, since the front wheels are also leading the vehicle through the curve, they must rotate faster than the rear wheels. With a solid four-wheel drive engagement there is no device (such as a differential) to counter this action in and the slower moving rear wheels act in an undesirable braking manner.

To solve beside this problem, one-way clutches have been employed in the transfer case so as the vehicle begins turning a corner, the front wheels (connected to transfer case output shaft through a one-way clutch) are allowed to disengage and free-wheel faster than the rear-wheels. Specifically, the driven shaft of the one-way clutch (i.e. the output shaft to the four-wheel drive front wheels) begins turning faster that the input, or driving, the shaft and the one-way clutch's locking mechanism disengages allowing free-wheeling of the output shaft relative to the input shaft. This momentarily takes the transfer case out of four-wheel drive and prevents the “tight corner braking effect”.

Another undesirable four-wheel drive driving effect happens during engine braking. This occurs in a manual transmission four-wheel drive vehicle when in four-wheel drive and coasting. The manual transmission maintains a physical connection to the vehicle engine, such that when the vehicle is allowed to coast, the engine places decelerating, or braking, force on the transfer case, both the input and output shafts, and ultimately on both the front and rear wheels. The normal and undesirable parasitic affect of engine braking through the rear wheels of a manual transmission two-wheel drive vehicle has a negative impact on fuel consumption and efficiency, which is greatly increased in the case of four-wheel drive vehicles by adding in the front wheels as well. In this instance, when a one-way clutch is used in a drive line of the transfer case, the slowing of the input shaft through the engine braking effect allows the output shaft (which is connected to the front wheels) to disengage and free wheel, momentarily taking the transfer case out of four-wheel drive and preventing the engine braking effect from passing through the front wheels, thereby reducing the negative impact on fuel efficiency.

Finally, in an on-demand application, a one-way clutch can be employed in the transfer case so that in the normal two-wheel drive mode, if one of those rear wheels should slip during vehicle acceleration, the rotating speed of the input shaft will increase, so that the one-clutch engaging elements will bring the transfer case into four-wheel drive and the front wheels into a driven mode.

While proving to be of great value, as transfer case design technology utilizing one-way clutches continues to evolve, the one-way clutch designs begin to reveal certain limitations. Most importantly, while a one-way clutch would solve the above-motioned problems and disadvantages, the one-way clutch would only work, by itself, in one direction. In other words, the one-way rotational forward engagement between the input and output shafts in the transfer case would allow forward four-wheel drive movement, but not reverse four-wheel drive movement. To provide this function, additional mechanisms and devices were added to the transfer case to supplement the one-way clutches. However, this added weight and complexity to the transfer case.

The concurrent ongoing design goals of reducing the mechanical complexity and physical bulk of transfer cases while increasing their functionally brought about the design of another torque transmitting device that adapted the one-way clutch mechanism to allow engagement in a bi-rotational, or two-way, manner. This device is typically known as a two-way clutch. The two-way clutch is desirable to solve all the above difficulties with four-wheel drive and provide full forward and reverse functionality. It allows the input shaft to be designed as the driving member for four-wheel drive modes, in both rotational directions, but offers bi-directional free-wheel movement of the driven output shaft as needed when the input shaft is stationary or rotating slower than the output shaft.

Yet, even though the conventional two-way clutch design has been very useful in solving these and other four-wheel drive driving difficulties, it has become apparent in applications that use a two-way clutch for a four-wheel drive engagement that certain deficiencies still exist which cause particular problems. Specifically, there exists a physical angular distance from the engaged inner connection between the races of the two-way clutch for the first rotational direction to the engagement of the races in the reverse, or second direction. This angular distance also known as backlash, can cause mechanical problems as the two-way clutch is repeatedly called on to change its driving rotational direction over the service life of the transfer case. This is due to the mechanical load brought to bear in the switch from one rotational direct to the other. This rotational shift takes a form of a high-impact shock loading that is not only absorbed by the two-way clutch, but is also translated to the other components attached to a two-way clutch in the drive line, all to a repetitive detrimental effect. The shock loading is detrimental as it reduces component life and reliability, while adding unpleasant ride characteristics to the vehicle.

Some attempts have been made to reduce the amount of backlash within a two-way clutch assembly but these generally have required substantial, or radical, redesigns of transfer case structure. In the typical two-way clutch currently used, the structurally inherent backlash can only be physically reduced to between about four and five degrees of rotation. Even this seemingly small amount of backlash causes the problems mentioned above.

Therefore, there exists a need to create an improved, clutch assembly for use as a driveline component within a transfer case that has a reduced, or minimal backlash, which will thereby reduced impact loading, extend the life of the clutch and associate components, and improve the riding characteristics of the vehicle.

### SUMMARY OF THE DISCLOSURE

In accordance with one aspect of the disclosure, a clutch is disclosed which comprises an inner race, an outer race, and a plurality of ratchet elements extending between the inner and outer races, the plurality of ratchet elements being disposed in multiple rows around the inner and outer races.

In accordance with another aspect of the disclosure, a method of operating a clutch with reduced backlash and bi-directional capacity is disclosed which comprises providing a clutch assembly including of an inner race, an outer race, a locking arm, a cam surface, and a shoulder, rotating the inner race clockwise relative to the outer race, such rotation causing the locking arm to slide along the cam surface thereby allowing inner race to move freely, and rotating the inner race counterclockwise relative to the outer race, such rotation causing the locking arm to engage the shoulder and preventing further rotation.

In accordance with another aspect of the disclosure, a motor vehicle transfer case is disclosed which comprises a housing formed by a case and a cover, the case being operatively coupled to an output of a transmission; an input shaft rotatably supported by an input roller bearing and the case; a primary output shaft rotatably supported by a rear output roller bearing in the cover; a secondary output shaft rotatably supported at the lower portion of the housing by a front output roller bearing, the secondary output shaft having a bell-shaped flange operatively coupled to a bulge joint to transmit torque; a drive sprocket splined to the primary output shaft and operatively coupled to a lower driven sprocket the lower driven sprocket being rotatably supported by a rear roller bearing to selectively transmit torque to the secondary output shaft; and a clutch assembly comprising of an inner race, an outer race and a plurality of ratchet elements extending between the inner and outer races, the plurality of ratchet elements being disposed in multiple rows around the inner and outer races.

These and other aspects and features of the disclosure will become more apparent upon reading the following detail description when taken in conjunction with the accompanying drawings.

### BRIEF DESCRIPTION OF THE DRAWINGS

FIG. 1 is a cross-sectional view of a transfer case employing a clutch manufactured in conjunction with the teachings of the disclosure;

FIG. 2 is a fragmentary view of one embodiment of the clutch assembly;

FIG. 3 is a cross-sectional view of the embodiment of FIG. 2, taken along line 3-3 of FIG. 2;

FIG. 4 is a cross-sectional view of the embodiment of FIG. 2, taken along line 4-4 of FIG. 2;

FIG. 5 is a cross-sectional view of another embodiment of the present disclosure employing three races with two sets of ratchet elements all extending in the same direction;

FIG. 6 is a cross-sectional view of another embodiment of the present disclosure, with two sets of ratchet elements extending in opposite directions; and

FIGS. 7A-E are alternative embodiments of the actual ratchet mechanism used in constructing a clutch in accordance with the teachings of the disclosure.

While the present disclosure is susceptible to various modifications and alternative embodiments, certain illustrative embodiments thereof have been shown in the drawings and will be described below in detail. It is to be understood, however, that there is no disclosure to limit the present disclosure to the specific forms disclosed, but on the contrary, the intention is to cover all modifications, alternative constructions, and equivalents falling within the spirit and scope of the present disclosure.

### DETAILED DESCRIPTION OF THE DISCLOSURE

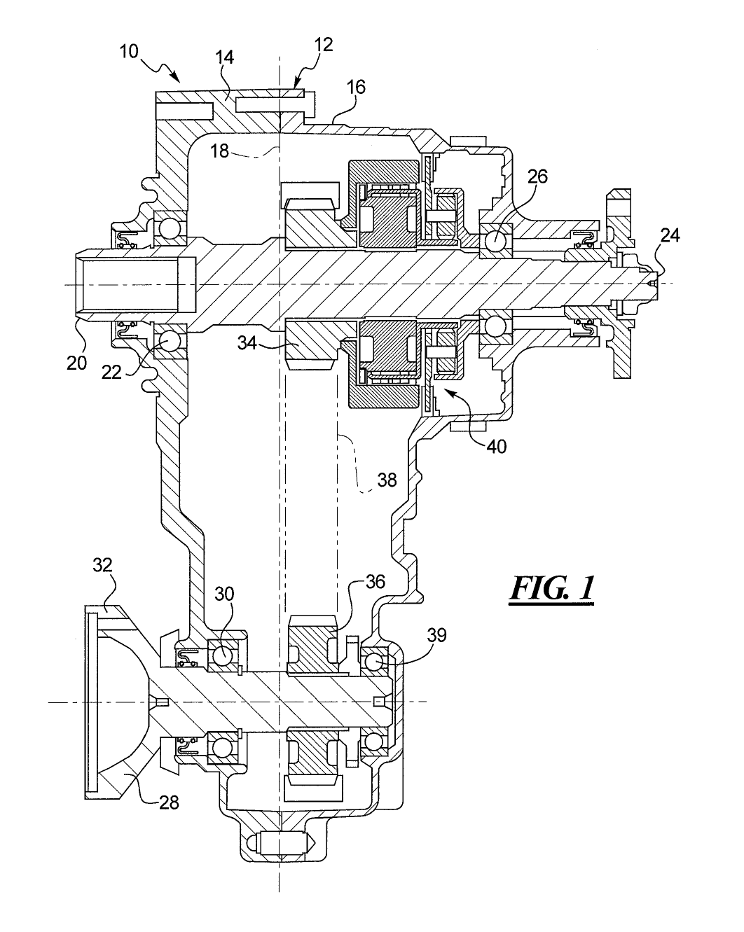

Referring now to the drawings and with specific reference to FIG. 1, a transfer case utilized in a four-wheel drive vehicle (not shown) and incorporating the present disclosure is generally referred to by reference numeral 10. The transfer case 10 includes a housing 12 which is formed by a case 14 and a cover 16 which mate along central line 18 in a conventional matter. An input shaft 20 is rotatably supported by an input roller bearing 22 and the case is operatively coupled to an output of a transmission in a conventional matter. Similarly, primary output shaft 24 is rotatably supported by a rear output roller bearing 26 in the cover 16 in the conventional matter. As will be noted in the drawings, the input and output shafts are integral, but those of ordinary skill in the art will appreciate that they may be in formed as two shafts splined together in a conventional matter. Together the input and output shafts define the main shaft of the transfer case.

In addition, the transfer case 10 of the present disclosure includes a secondary output shaft 28 rotatably supported at the lower portion of the housing 12 by a front output roller bearing 30. The secondary output shaft 28 has a bell-shape flange 32 which is operatively coupled to a bulge joint (not shown) to transmit torque to the front wheels of the vehicle when it is in the four-wheel drive mode.

A drive sprocket 34 is splined to the primary output shaft 24 and rotates therewith in the upper portion of housing 12. The drive sprocket 34 is operatively coupled to a lower driven sprocket 36 by a chain 38 shown in phantom. The lower driven sprocket 36 is rotatably supported in the lower portion of the housing 12 by rear roller bearing 39 to selectively transmit torque to the secondary output shaft 28. The one speed transfer case 10 described after this point is conventional in the art.

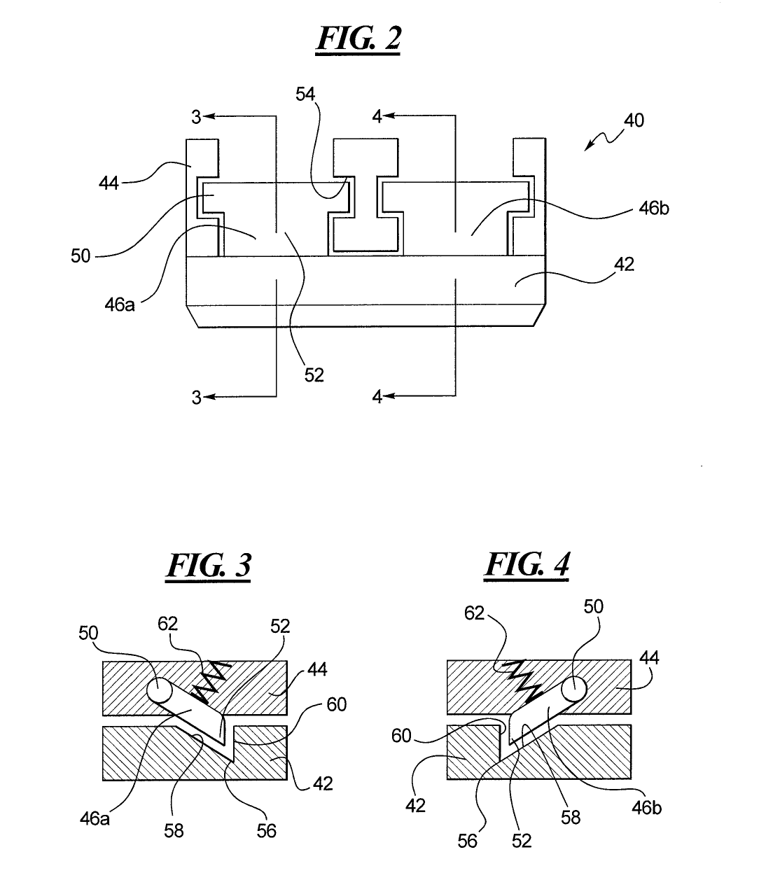

However, with reference to the clutch of the present disclosure it is generally referenced to by reference numeral 40. As shown best in FIG. 2, in a first embodiment, the clutch 40 can include an inner race 42, and outer race 44, and a plurality of ratchet elements 46 extended between the inner and outer races 42 and 44. The ratchet elements 46 may be provided in a first circumferential row 46a, and a second circumferential row 46b.

As will be understood by one of ordinary skill in the art, the ratchet elements 46 could include a pivot axle 50 from which extends a locking arm 52. The outer race 44 could be machined to have a plurality of mounting recesses 54 into which each ratchet element 46 could be pivotably mounted. In other embodiments, the plurality of ratchet elements 46 could be similarly mounted for pivotal motion in the inner race 42.

Referring now to FIG. 3, the first row of ratchet elements 46a is shown in more detail by way of cross-section. As shown, the pivot axle 50 is mounted in the outer race 44 with the locking arm 52 extending toward the inner race 42 in a clockwise direction. In turn, the inner race 42 is provided with a plurality of notches 56 into which the ratchet elements 46 can engage and disengage. More specifically, each notch 56 includes a cam surface 58 and a shoulder 60. The cam surface 58 is angled such that clockwise rotation of the inner race 42 relative to the outer race 44 causes the locking arm 52 to slide along the cam surface 58 thereby allowing the inner race 42 to freely move. However, when the inner race 42 tries to rotate in the counterclockwise direction relative to the outer race 44, the locking arm 52 engages the shoulder 60 and prevents such rotation. A spring 62 is associated with each ratchet element 46 to bias the locking arms 52 toward the notches 56.

Concurrent with the first row of ratchet elements 46a, however, is the second row of ratchet elements 46b also mounted in the outer race 44. As shown in FIG. 2, the second row 46b may be circumferentially provided around the outer race 44, but simply laterally spaced therefrom. In addition, the second row of ratchet elements 46b may extend in the same clockwise direction as the first row 46a, or as shown in FIG. 4, could be mounted so as to extend in the opposite, counterclockwise direction. If mounted in the same direction, the resulting clutch assembly could have a significantly reduced backlash as compared to conventional clutches, e.g., on the order of a fifty percent reduction. Accordingly, the present disclosure is referred to herein as having a reduced backlash factor of, for example, 0.5. If mounted in opposite directions, the resulting clutch assembly could operate in a bi-directional capacity as will be explained in more detail herein.

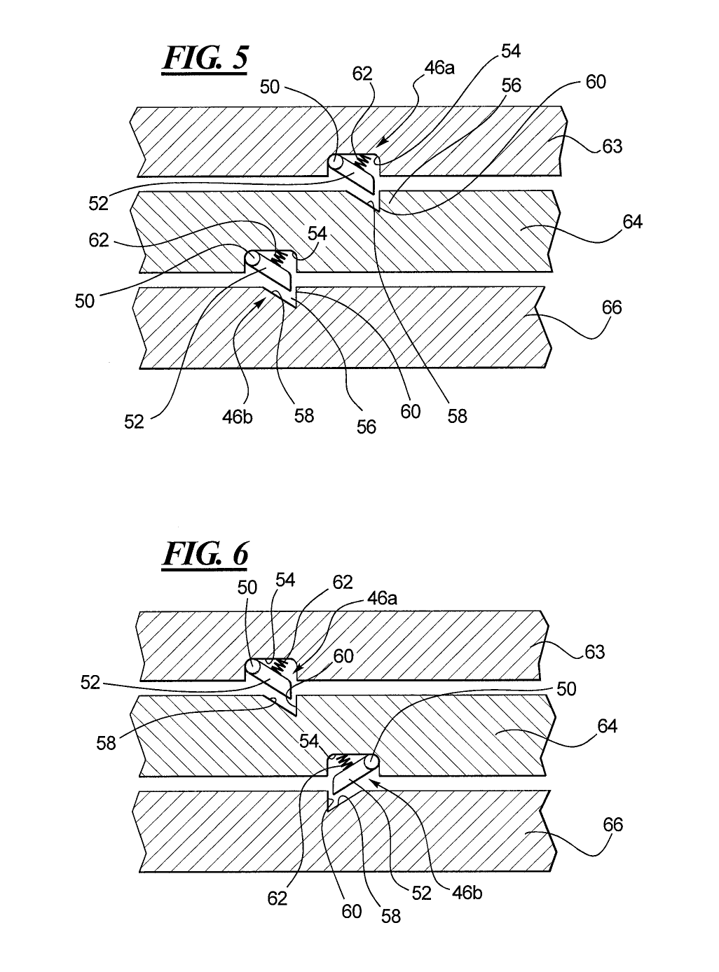

In still further alternative embodiments, the first and second rows of ratchet elements 46a, 46b may extend between more than two races. In other words, such a clutch may include first, second, and third race 63, 64, 66 with the first row of ratchet elements 46a extending between the first race 63 and the second race 64, and with the second row of ratchet elements 46b extending between the second race 64 and the third race 66. In addition, as with the previous embodiments, the first and second rows of ratchet elements 46a and 46b can be mounted to extend in the same direction (clockwise in FIG. 5), or in opposite directions as shown in FIG. 6, to either reduce backlash, or allow for bi-directional use. With specific reference to the latter embodiments, it can be seen that bi-directional mounting allows for four distinct modes of operation, specifically: (1) freewheel/overrun in both clockwise and counterclockwise directions; (2) locks/transmits torque in both clockwise and counterclockwise directions; (3) locks in clockwise direction and overruns in counterclockwise direction; and (4) locks in counterclockwise direction and overruns in clockwise direction.

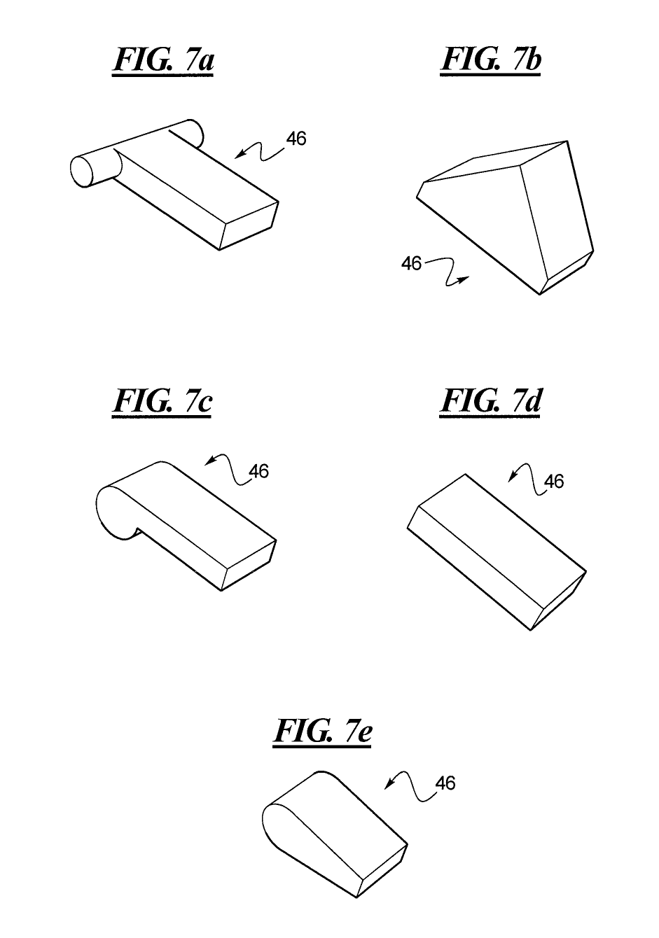

Finally, FIGS. 7A-E depict different embodiments of the types and shapes of ratchet elements 46 that can be employed with the present disclosure. Those shown are simply exemplary and not meant to be exhaustive. In addition, while mention has been made in the foregoing primarily to radial ratchet clutches, it is to be understood that the use of multiple circumferential rows of elements could be employed with other types of clutches including, but not limited to, roller clutches, sprag clutches, and the like.

From the foregoing, it can therefore be seen that the disclosure can be used to construct a clutch with greatly reduced backlash, e.g. up to a fifty percent reduction. In addition, the orientation of the races and plurality of ratchet elements can be used so as to create a selectable clutch having at least having four modes of operation.

1) A clutch, comprising:
an inner race;
an outer race; and
a plurality of ratchet elements extending between the inner and outer races, the plurality of ratchet elements being disposed in multiple rows around the inner and outer races.

2) The clutch of claim 1, further comprising:
a third race;
a second plurality of ratchet elements extending between the outer race and the third race.

3) The clutch of claim 1, wherein some of the ratchet elements extend in a clockwise direction, and some of the ratchet elements extend in a counterclockwise direction.

4) The clutch of claim 1, wherein the ratchet elements include a pivot axle from which extends a locking arm.

5) The clutch of claim 1, wherein the outer race is machined to have a plurality of mounting recesses into which each ratchet element is pivotably mounted.

6) The clutch of claim 1, wherein the inner race is machined to have a plurality of mounting recesses into which each ratchet element is pivotably mounted.

7) The clutch of claim 1, wherein the inner race is provided with a plurality of notches into which the ratchet elements engage and disengage.

8) The clutch of claim 1, wherein the inner race comprises of a plurality of notches, each notch including a cam surface and a shoulder, the cam surface being angled such that the locking arm slides freely, and the shoulder engaging the locking arm to prevent further rotation.

9) The clutch of claim 1, wherein each ratchet element is associated with a spring, the spring biasing the locking arm toward the notch.

10) A method of operating a clutch with reduced backlash and bi-directional capacity, comprising:
providing a clutch assembly including of an inner race, an outer race, a locking arm, a cam surface, and a shoulder;
rotating the inner race clockwise relative to the outer race, such rotation causing the locking arm to slide along the cam surface thereby allowing inner race to move freely; and
rotating the inner race counterclockwise relative to the outer race, such rotation causing the locking arm to engage the shoulder and preventing further rotation.

11) The method of claim 10, further comprising of multiple rows of ratchet elements mounted in the same direction or opposite directions.

12) The method of claim 11, wherein the rotating steps allow for bi-directional use.

13) The method of claim 10, wherein rows of ratchet elements mounted in the same direction provide a reduced backlash factor of 0.5.

14) The method of claim 10, wherein rows of ratchet elements mounted in opposite directions allow for bi-directional use of four distinct operational modes:
a) freewheel/overrun in both clockwise and counterclockwise directions;
b) locks/transmits torque in both clockwise and counterclockwise directions;
c) locks in clockwise direction and overruns in counterclockwise direction; and
d) locks in counterclockwise direction and overruns in clockwise direction.

15) A motor vehicle transfer case, comprising:
a housing formed by a case and a cover, the case being operatively coupled to an output of a transmission;
an input shaft rotatably supported by an input roller bearing and the case;
a primary output shaft rotatably supported by a rear output roller bearing in the cover;
a secondary output shaft rotatably supported at the lower portion of the housing by a front output roller bearing, the secondary output shaft having a bell-shaped flange operatively coupled to a bulge joint to transmit torque;
a drive sprocket splined to the primary output shaft and operatively coupled to a lower driven sprocket the lower driven sprocket being rotatably supported by a rear roller bearing to selectively transmit torque to the secondary output shaft; and
a clutch assembly comprising of an inner race, an outer race and a plurality of ratchet elements extending between the inner and outer races, the plurality of ratchet elements being disposed in multiple rows around the inner and outer races.

16) The motor vehicle transfer case of claim 15, wherein some of the ratchet elements of the clutch assembly extend in a clockwise direction and some of the ratchet elements extend in a counterclockwise direction.

17) The motor vehicle transfer case of claim 15, wherein the clutch assembly allows for bi-directional use.

18) The motor vehicle transfer case of claim 15, wherein the clutch assembly reduces backlash by mounting some of the rows of ratchet elements in the same direction.

19) The motor vehicle transfer case of claim 15, wherein the clutch assembly provides a reduced backlash factor of 0.5 when mounting some of the rows of ratchet elements in the same direction.

20) The motor vehicle transfer case of claim 15, wherein the clutch assembly allows bi-directional use of four operational modes:
a) freewheel/overrun in both clockwise and counterclockwise directions;
b) locks/transmits torque in both clockwise and counterclockwise directions;
c) locks in clockwise direction and overruns in counterclockwise direction; and
d) locks in counterclockwise direction and overruns in clockwise direction.
